(19) United States
(12) Patent Application Publication
(10) Pub. No.: US 2012/0291304 A1
(43) Pub. Date: Nov. 22, 2012

(54) DIELECTRIC DRYER DRUM

(75) Inventors: David S. Wisherd, Carmel, CA (US); John A. Eisenberg, Los Altos, CA (US); Pablo E. D'Anna, Redding, CA (US)

(73) Assignee: COOL DRY LLC, San Jose, CA (US)

(21) Appl. No.: 13/112,880

(22) Filed: May 20, 2011

(51) Int. Cl. F26B 3/34

(52) U.S. Cl. 34/255

(57) ABSTRACT

A method for heating an object having a variable weight that includes a medium is provided. The method comprises: (A) placing the object having the variable weight including medium into an enclosure; (B) initiating a heating process by subjecting medium including the object having the variable weight to a variable AC electrical field; and (C) controlling the heating process. The object has substantially absorbed medium in a first “cool” state and therefore includes a maximum weight in the first “cool” state due to absorption of medium. The object is substantially free from medium in a second “heated” state due to substantial release of medium from the object, wherein the released medium is evaporated during the heating process. The heating process is completed when the object is substantially transitioned into the second “heated” state. The method further comprises using an air flow having an ambient temperature inside the enclosure to carry away the evaporated medium from the enclosure.

### TECHNICAL FIELD

The technology relates to the field of Radio Frequency (RF) heating systems.

### BACKGROUND

Conventional clothes dryers heat a large volume of air that then passes over tumbling clothes. Water is extracted from the wet clothes by evaporation into the heated air. This conventional drying process is extremely inefficient, as at least 85% of the energy consumed by the machine goes out the vent.

The stated above inefficiency of conventional drying process is due to the fact that air is a very poor heat conductor. Thus, for example, only very small engines can be air cooled efficiently. On the other hand, some large engines, for example, an automobile engine, or a high power motorcycle engine, use water cooling because water is much better heat conductor than air.

### SUMMARY

This Summary is provided to introduce a selection of concepts that are further described below in the Detailed Description. This Summary is not intended to identify key or essential features of the claimed subject matter, nor is it intended to be used as an aid in determining the scope of the claimed subject matter.

A method for heating an object having a variable weight that includes a medium is provided. The method comprises: (A) placing the object having the variable weight including medium into an enclosure; (B) initiating a heating process by subjecting medium including the object having the variable weight to a variable AC electrical field; and (C) controlling the heating process.

The object has substantially absorbed medium in a first “cool” state and therefore includes a maximum weight in the first “cool” state due to absorption of medium.

The object is substantially free from medium in a second “heated” state due to substantial release of medium from the object, wherein the released medium is evaporated during the heating process. The heating process is completed when the object is substantially transitioned into the second “heated” state.

The method further comprises using an air flow having an ambient temperature inside the enclosure to carry away the evaporated medium from the enclosure.

### DESCRIPTION OF THE DRAWINGS

The accompanying drawings, which are incorporated in and form a part of this specification, illustrate embodiments of the technology and, together with the description, serve to explain the principles below:

FIG. 1 illustrates a general diagram of a dielectric dryer drum for the purposes of the present technology.

FIG. 2 shows a basic impellor anode RF dryer diagram for the purposes of the present technology.

FIG. 3 depicts a dielectric heating system block diagram for the purposes of the present technology.

FIG. 4 illustrates the comparison between the conventional heated air dryer and the proprietary Cool Dry dielectric dryer for the purposes of the present technology.

FIG. 5 shows a dryer drum and single impellor design example for the purposes of the present technology.

FIG. 6 depicts RF connections to rotating elements cathode & anode for the purposes of the present technology.

FIG. 7 illustrates variable anode element coupling for the purposes of the present technology.

FIG. 8 shows a dielectric load model of the dielectric dryer drum for the purposes of the present technology.

### DETAILED DESCRIPTION

Reference now is made in detail to the embodiments of the technology, examples of which are illustrated in the accompanying drawings. While the present technology will be described in conjunction with the various embodiments, it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following detailed description, numerous specific-details are set forth in order to provide a thorough understanding of the presented embodiments. However, it will be obvious to one of ordinary skill in the art that the presented embodiments may be practiced without these specific details. In other instances, well known methods, procedures, components, and circuits have not been described in detail as not to unnecessarily obscure aspects of the presented embodiments.

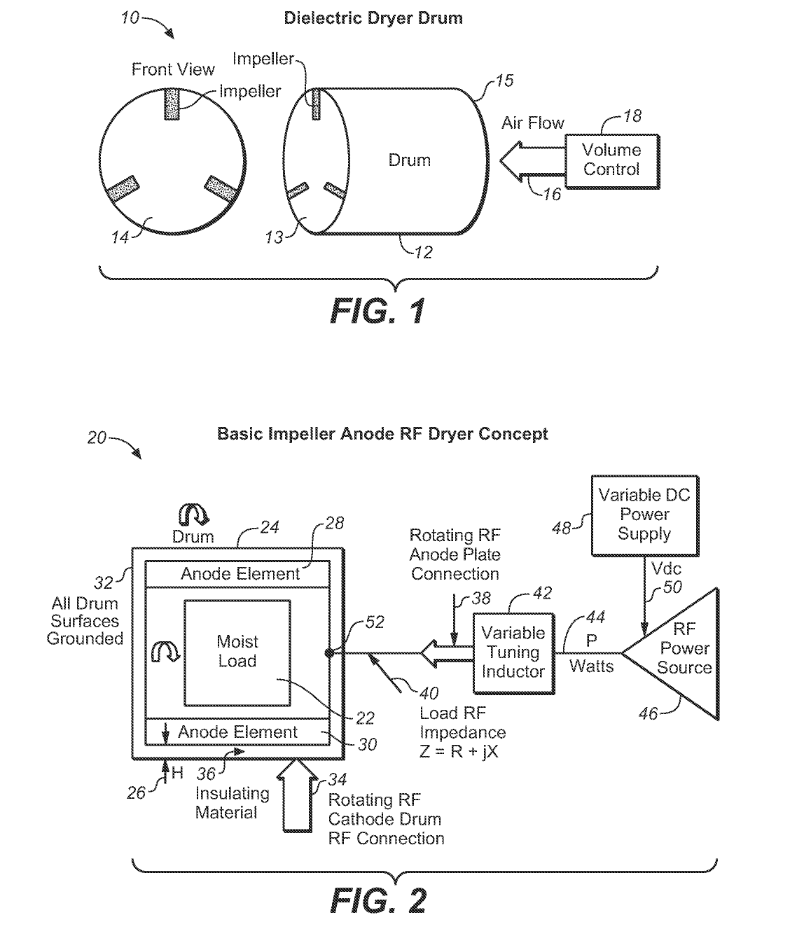

In an embodiment of the present technology, FIG. 1 illustrates a general diagram 10 of a dielectric dryer drum 12 for the purposes of the present technology. This represents a new way to introduce the RF power into the dryer chamber.

In an embodiment of the present technology, more specifically, the cylindrical drum 12 having two round cathode plate ends 13 and 15 includes at least three impellors 14 utilized to introduce the RF power (please, see discussion below). An air flow 16 is used to efficiently carry out the evaporated water off the system.

In an embodiment of the present technology, the volume control block 18 is employed for controlling an air flow rate to facilitate removal of evaporated water from the drum 12.

In an embodiment of the present technology, an air path is controlled by selecting an element design (from the group consisting of: an intake air duct design (not shown), an air chamber design (not shown), and a drum impellor design (see discussion below). The element design is configured to facilitate removal of evaporated water from the drum 12.

Essentially this new way to introduce the RF into the chamber allows us to maintain the size and volume of the chamber constant, without moving parts inside. Also, the tuning out of the reactive component of the load could be accomplished by turning on or off, all or some of the impellor vanes inside the drum.

In an embodiment of the present technology, referring still to FIG. 1 the impellors 14 of the dielectric dryer drum 12 now have a double function: to scramble the clothes for better exposure to the air that removes the moisture, and also to provide the RF anode connection.

In an embodiment of the present technology, more specifically, the impellors 14 of the dryer drum 12 are now used as anodes for connection to the load with variable materials (including fabrics), weight and moisture.

In an embodiment of the present technology, the load effective shape and volume is varied by the drum rotation speed & direction, drum shape and impellor design to optimize energy transfer from the RF power source to the load over the drying cycle.

For example, semispherical protrusions (not shown) could be engineered on the end plates to help put tumbling clothes into a more optimum dynamic shape for RF coupling.

In an embodiment of the present technology, FIG. 2 shows a basic impellor anode RF dryer diagram 20 for the purposes of the present technology.

In an embodiment of the present technology, the drum material 24 is selected from the group consisting of: a conductor; a metal; an insulator; a dielectric insulator; a ceramic insulator; a plastic insulator; a wooden insulator; and a mixture of at least two drum materials.

In an embodiment of the present technology, an object inside the rotating drum 24 is selected from the group consisting of: a cloth substance; a food substance; a wood substance; a plastic substance; and a chemical substance.

In an embodiment of the present technology, we will focus on the object 22 comprising a moist load of clothing. In an embodiment of the present technology, all drum surfaces are grounded 26.

In an embodiment of the present technology, each drum impellor is driven with RF energy as a “hot anode” (28, 30), with ground return being the entire drum surface 32. Each impellor is shaped and placed into the drum in a manner to maximize RF coupling to the tumbling, or stationary, load while minimizing non load coupled “parasitic” capacitance.

In an embodiment of the present technology, each anode element (28, 30) is separated from the conductive drum surface 32 by an insulating material 36.

In an embodiment of the present technology, the insulating material 36 is selected from the group consisting of: glass; plastic; and ceramic.

In an embodiment of the present technology, referring still to FIG. 2, the conductive cathode area 32 of the rotating drum 24 is connected to the ground return path 26 of the RF power source by a connection selected from a from the group consisting of: a rotating capacitive connection; and a non rotating capacitive connection.

In an embodiment of the present technology, referring still to FIG. 2, we will focus our discussion on the rotating RF cathode drum RF connection 34.

In an embodiment of the present technology, referring still to FIG. 2, at least one anode element (28, 30) is connected to the RF power source 46 by a connector comprising the rotating RF anode plate connector 38.

In an embodiment of the present technology, the rotating RF anode plate connector 38 is connected to RF Power source 46 by using a variable tuning inductor 42.

In an embodiment of the present technology, the variable tuning inductor 42 is used to achieve the RF tuning for optimum power transfer from the DC Supply voltage 48.

In an embodiment of the present technology, the drum is rotated with varying rotation speed to optimize RF coupling.

In an embodiment of the present technology, the direction of rotation of said drum is varied to optimize RF coupling by preventing bunching of the drying load.

In an embodiment of the present technology, the variable tuning inductor 42 adjusts its value to tune out the (−jX) from the load RF impedance 40, thus yielding a pure resistive load, R at the feed point 52

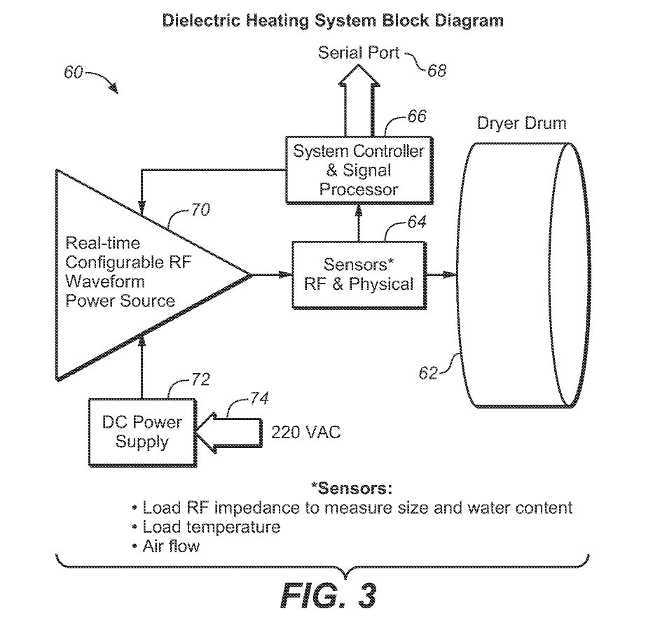

In an embodiment of the present technology, FIG. 3 depicts a dielectric heating system bloc diagram 60 comprising a DC power supply 72, a real time configurable RF waveform power source 70, a system controller & signal processor 66, a serial port 68, a block 64 of RF & physical sensors; and a dryer drum 62.

In an embodiment of the present technology, the heating process is controlled by selecting parameters of the real time configurable RF waveform power source 70 from the group consisting of: an applied RF voltage magnitude and envelope wave shape; an applied RF current magnitude and envelope wave shape; phase of RF voltage vs. current; voltage standing wave ratio (VSWR); and RF frequency.

In an embodiment of the present technology, the block 64 of RF & physical sensors are configured to measure the load RF impedance in order to measure the size and water content of the load, to measure the load temperature, and to measure parameters of the air flow.

In an embodiment of the present technology, the system controller & signal processor 66 is configured to control parameters of the real time configurable RF waveform power source 70 by using the real time data provided by the block 64 of RF & physical sensors.

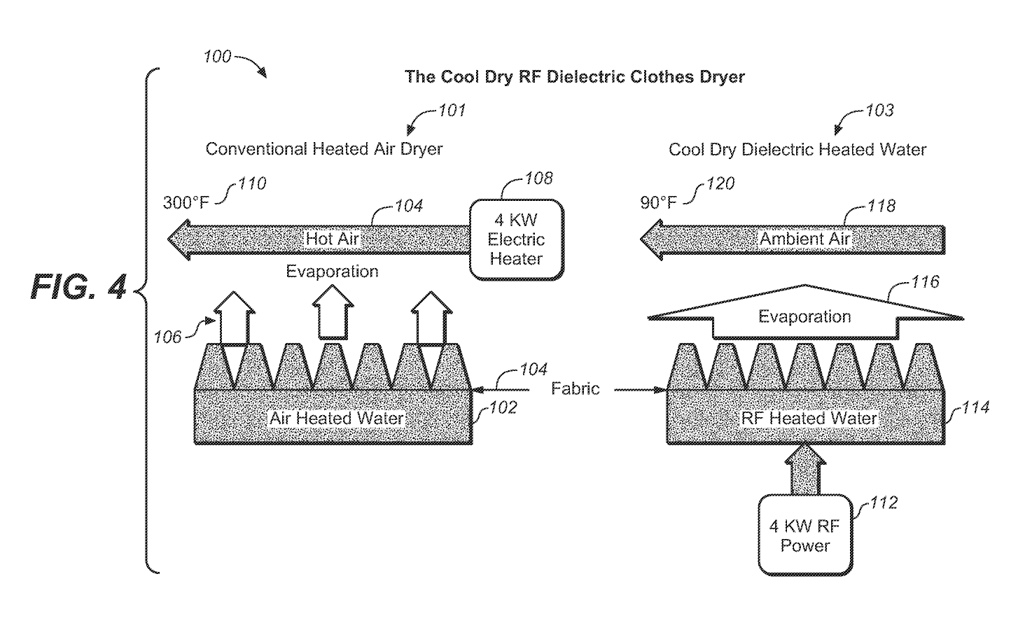

FIG. 4 illustrates the comparison diagram 100 between the conventional heated air dryer 101 and the proprietary Cool Dry dielectric dryer 103 for the purposes of the present technology.

In the conventional heated air dryer, the 4 kW applied power 108 causes heating of the hot air 104 up to 300° F. 110 due to evaporation of air heated water 106. Such hot temperature adversely affects the properties of the drying fabric.

On the other hand, in the proprietary Cool Dry dielectric dryer 103 the 4 kW applied RF power 112 causes evaporation of air heated water 114 but does not cause heating of the ambient air 118 that has temperature only up to 90° F. (room temperature). Such ambient temperature does not adversely affect the properties of the drying fabric.

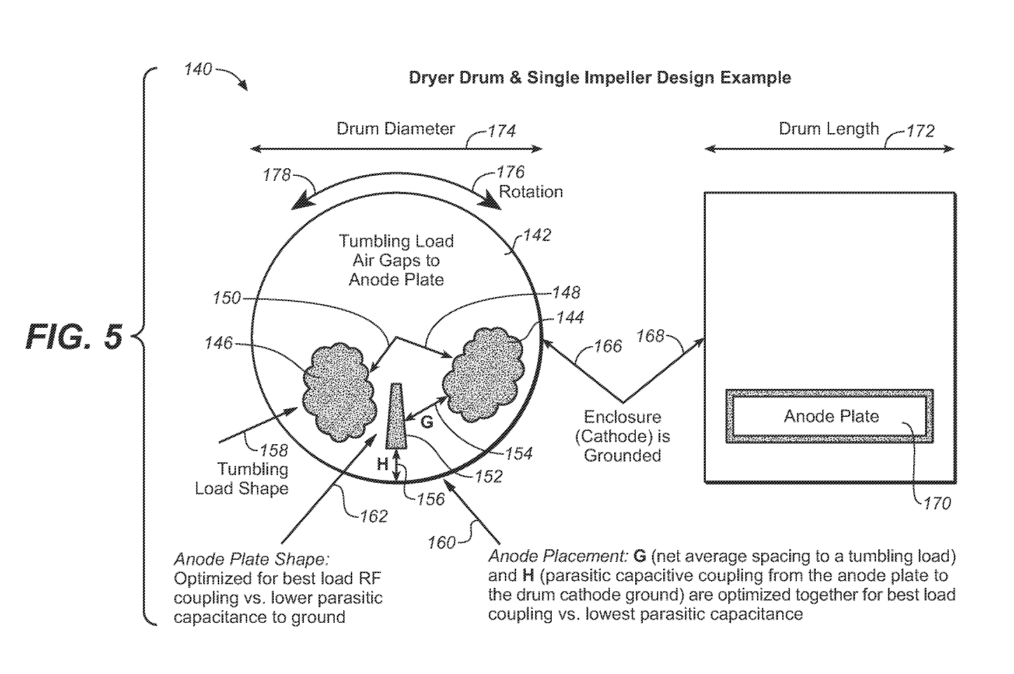

FIG. 5 shows a dryer drum and single impellor design example 140 for the purposes of the present technology. There are tumbling load air gaps between the tumbling loads 150 and 148 and the anode plate 162 depending on the tumbling load shape 158 and the anode shape 162 and placement 160.

In an embodiment of the present technology, the anode plate shape 162 is optimized for best load RF coupling vs. lower parasitic capacitance to ground.

In an embodiment of the present technology, the anode plate shape 162 is optimized to accommodate for different kind of fabrics and different kind of load.

In an embodiment of the present technology, the anode plate placement 160 is also optimized so that the parameter G 154 (net average spacing to a tumbling load) and the parameter H 156 (parasitic capacitive coupon from the anode plate to the drum cathode ground) are optimized together for best load coupling vs. lower parasitic capacitance to ground.

In an embodiment of the present technology, the rotating RF anode plate connector 38 (of FIG. 3) is selected from the group consisting of: a brush-contact commutator; and a capacitive coupling.

In an embodiment of the present technology, the rotating RF anode plate connector 38 (of FIG. 3) comprises a capacitive coupling selected from the group consisting of: a parallel plate; and at least one concentric cylinder.

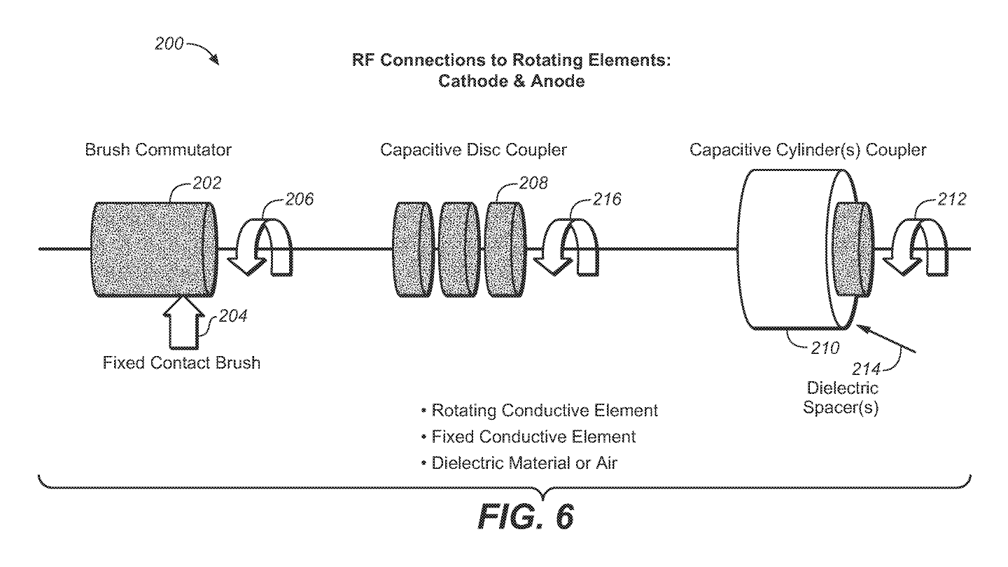

More specifically, FIG. 6 depicts diagram 200 of RF connections to rotating elements cathode & anode for the purposes of the present technology.

In an embodiment of the present technology, the anode plate is connected to the RF source by using a fixed contact brush (204 of FIG. 6).

In an embodiment of the present technology, the anode plate is connected to the RF source by using a rotating brush commutator (202 of FIG. 6).

In an embodiment of the present technology, the anode plate is connected to the RF source by using a capacitive disc coupler (208 of FIG. 6).

In an embodiment of the present technology, the anode plate is connected to the RF source by using at least one capacitive cylinder disc coupler (210 of FIG. 6).

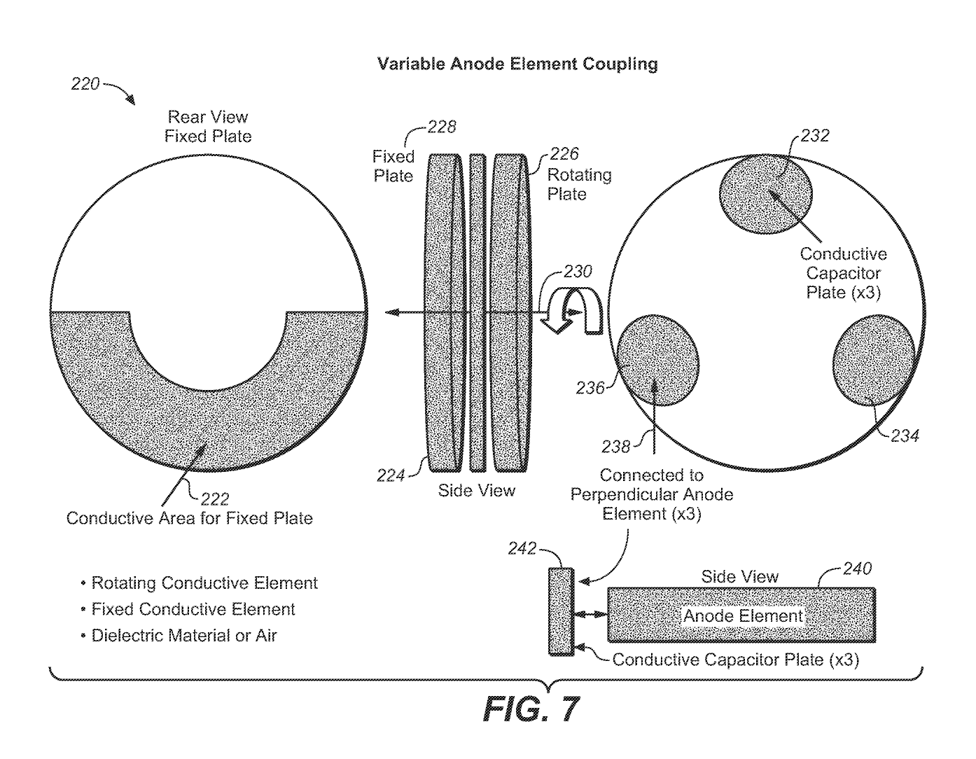

FIG. 7 is a diagram 220 that illustrates variable anode element coupling for the purposes of the present technology.

In an embodiment of the present technology, the conductive area of the fixed anode plate 222 is shown in a rear view.

In an embodiment of the present technology, the fixed anode plate 228 and rotating plate 226 are shown in a side view 224.

In an embodiment of the present technology, the conductive capacitor plates 232, 234, and 236 are perpendicular (shown by legend 242) connected to the anode element 240.

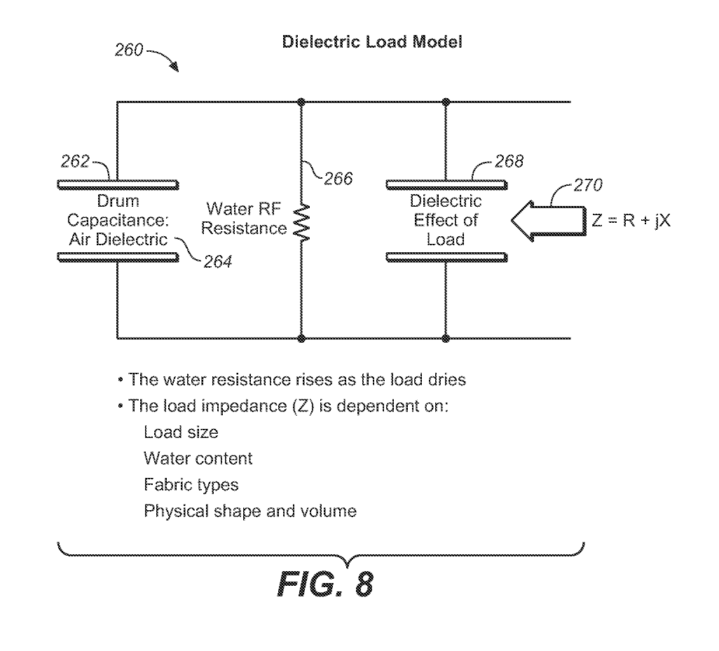

FIG. 8 shows the dielectric load model 260 of the dielectric dryer drum for the purposes of the present technology.

The drum has a fundamental capacitance, 262 based on its physical dimensions and air dielectric permittivity 264. The water in the load has an RF resistance 266 related to the amount of water contained. The materials in the load add an additional capacitance 268 to the model, based on their dielectric constant >1. Thus, the load impedance 270 is:

Z=R+jX (Eq. 1)

The load impedance Z is dependent on: load size, water content; fabric types, and physical shape and volume.

The basic principle is dynamically maximized RF coupling to the load resistance (water). The design optimizes the water resistance while minimizing parasitic capacitance 268.

In an embodiment of the present technology, the capacitive element of the load 268 could be minimized or perhaps totally eliminated by driving a different number of impellors with the RF source during the drying cycle. with mechanically staggered coupling capacitors.

In an embodiment of the present technology, as was disclosed above, FIG. 2 illustrates an example of the design optimization by the spacing of the impellor anode above the drum ground to minimize capacitance consistent with optimum load coupling.

In an embodiment of the present technology, the RF impedance of the load can be used to measure water content in real-time.

In an embodiment of the present technology, the method for heating an object having a variable weight that includes a medium comprises the step of placing the object having the variable weight including the medium into an enclosure; wherein the object substantially has absorbed the medium in a first “cool” state; and wherein the object includes a maximum weight in the first “cool” state due to absorption of the medium.

In an embodiment of the present technology, the method for heating an object having a variable weight that includes a medium further comprises the step of initiating a heating process by subjecting the medium including the object to a variable AC electrical field; wherein the object is substantially free from the medium in a second “heated” state due to substantial release of the medium from the object; and wherein the released medium is evaporated during the heating process.

In an embodiment of the present technology, the method for heating an object having a variable weight that includes a medium further comprises the step of controlling the heating process, wherein the heating process is completed when the object is substantially transitioned into the second “heated” state.

In an embodiment of the present technology, the method for heating an object having a variable weight that includes a medium further comprises the step of using an air flow having an ambient temperature inside the enclosure to carry away the evaporated medium from the enclosure.

In an embodiment of the present technology, wherein the enclosure comprises a dryer drum 24 version of the enclosure having at least one anode element impellor 28 (30) of variable shape, and at least one cathode area 32, and wherein the object comprises a load of clothing 22, and wherein the medium comprises water, as shown in FIG. 2, the method for heating the load of clothing 22 further comprises the step of optimally configuring the shape of at least one anode (impeller) to accommodate for different kind of fabrics and different kind of load.

In an embodiment of the present technology, wherein the enclosure comprises a dryer drum 24 version of the enclosure having at least one anode element impellor 28 (30) of variable shape, and at least one cathode area 32, and wherein the object comprises a load of clothing 22, and wherein the medium comprises water, as shown in FIG. 2, the method for heating the load of clothing 22 further comprises the step of pre-heating air inside the dryer drum 24 to facilitate water evaporation from the drum.

In an embodiment of the present technology, wherein the enclosure comprises a dryer drum 24 version of the enclosure having at least one anode element impellor 28 (30) of variable shape, and at least one cathode area 32, and wherein the object comprises a load of clothing 22, and wherein the medium comprises water, as shown in FIG. 2, the method for heating the load of clothing 22 further comprises the step of controlling an air flow rate by volume control block (18 of FIG. 1) to facilitate removal of evaporated water from the drum enclosure.

In an embodiment of the present technology, wherein the enclosure comprises a dryer drum 24 version of the enclosure having at least one anode element impellor 28 (30) of variable shape, and at least one cathode area 32, and wherein the object comprises a load of clothing 22, and wherein the medium comprises water, as shown in FIG. 2, the method for heating the load of clothing 22 further comprises the step of controlling an air flow path by an element design selected from the group consisting of: an intake air duct design (not shown); a chamber design (not shown); and a drum impellor design (162 of FIG. 5). The element design is configured to facilitate removal of evaporated water from the drum enclosure.

The above discussion has set forth the operation of various exemplary systems and devices, as well as various embodiments pertaining to exemplary methods of operating such systems and devices. In various embodiments, one or more steps of a method of implementation are carried out by a processor under the control of computer-readable and computer-executable instructions. Thus, in some embodiments, these methods are implemented via a computer.

In an embodiment, the computer-readable and computer-executable instructions may reside on computer useable/readable media.

Therefore, one or more operations of various embodiments may be controlled or implemented using computer-executable instructions, such as program modules, being executed by a computer. Generally, program modules include routines, programs, objects, components, data structures, etc., that perform particular tasks or implement particular abstract data types. In addition, the present technology may also be practiced in distributed computing environments where tasks are performed by remote processing devices that are linked through a communications network. In a distributed computing environment, program modules may be located in both local and remote computer-storage media including memory-storage devices.

Although specific steps of exemplary methods of implementation are disclosed herein, these steps are examples of steps that may be performed in accordance with various exemplary embodiments. That is, embodiments disclosed herein are well suited to performing various other steps or variations of the steps recited. Moreover, the steps disclosed herein may be performed in an order different than presented, and not all of the steps are necessarily performed in a particular embodiment.

Although various electronic and software based systems are discussed herein, these systems are merely examples of environments that might be utilized, and are not intended to suggest any limitation as to the scope of use or functionality of the present technology. Neither should such systems be interpreted as having any dependency or relation to any one or combination of components or functions illustrated in the disclosed examples.

Although the subject matter has been described in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A method for heating an object having a variable weight that includes a medium; said method comprising:
(A) placing said object having said variable weight including said medium into an enclosure; wherein said object substantially has absorbed said medium in a first “cool” state; and wherein said object includes a maximum weight in said first “cool” state due to absorption of said medium;
(B) initiating a heating process by subjecting said medium including said object having said variable weight to a variable AC electrical field; wherein said object is substantially free from said medium in a second “heated” state due to substantial release of said medium from said object; and wherein said released medium is evaporated during said heating process;
and
(C) controlling said heating process, wherein said heating process is completed when said object is substantially transitioned into said second “heated” state.

2. The method of claim 1 further comprising:
(D) using an air flow having an ambient temperature inside said enclosure to carry away said evaporated medium from said enclosure.

3. The method of claim 1, wherein said step (A) further comprises:
(A1) selecting said medium from the group consisting of: water; a liquid having a dielectric permittivity above a first predetermined threshold; and a liquid having a dissipation factor above a second predetermined threshold.

4. The method of claim 1, wherein said step (A) further comprises:
(A2) selecting said object from the group consisting of:
a cloth substance; a food substance; a wood substance; a plastic substance; and a chemical substance.

5. The method of claim 1, wherein said step (A) further comprises:
(A3) selecting an enclosure having at least one anode element.

6. The method of claim 1, wherein said step (A) further comprises:
(A4) selecting an enclosure from the group consisting of:
a cylindrical cathode drum having at least one impellor; and a cylindrical drum having at least one impellor and having at least one cathode end plate.

7. The method of claim 1, wherein said step (A) further comprises:
(A5) selecting an enclosure material from the group consisting of:
a conductor; a metal; an insulator; a dielectric insulator; a ceramic insulator; a plastic insulator; a wooden insulator; and a mixture of at least two drum materials.

8. The method of claim 1, wherein said step (B) further comprises:
(B1) applying RF energy to at least one said anode element within said enclosure.

9. The method of claim 1, wherein said step (B) further comprises:
(B2) applying RF energy to at least one said impellor configured to function as an anode element inside a drum enclosure; and wherein at least part of said conductive drum surface is configured to function as a cathode ground return; and wherein at least one said anode element is separated from said conductive drum surface by an insulating material.

10. The method of claim 9, wherein said step (B2) further comprises:
(B2, 1) selecting said insulating material from the group consisting of:
glass; plastic; and ceramic.

11. The method of claim 1, wherein said step (B) further comprises:
(B3) shaping at least one said anode element to optimize RF energy coupling to said load.

12. The method of claim 1, wherein said step (B) further comprises:
(B4) shaping at least one said impellor anode element within said drum enclosure to maximize RF coupling to a tumbling load.

13. The method of claim 1, wherein said step (B) further comprises:
(B5) shaping at least one said impellor anode element within said drum enclosure to maximize RF coupling to a stationary load.

14. The method of claim 1, wherein said step (B) further comprises:
(B6) configuring at least one said anode element to minimize coupled parasitic capacitance.

15. The method of claim 1, wherein said step (B) further comprises:
(B7) spacing at least one said impellor anode element within a drum enclosure away from said drum surface.

16. The method of claim 1, wherein said step (B) further comprises:
(B8) shaping said enclosure to maximize RF coupling to the load.

17. The method of claim 1, wherein said step (B) further comprises:
(B9) shaping at least one surface area of a drum shaped enclosure to maximize RF coupling to the load.

18. The method of claim 1, wherein said step (B) further comprises:
(B10) making at least one protrusion on at least one end plate of a drum enclosure to optimize RF coupling; said at least one protrusion is selected form the group consisting of: a concave protrusion; and a convex protrusion.

19. The method of claim 1, wherein said step (B) further comprises:
(B11) rotating said drum with varying rotation speed to optimize RF coupling.

20. The method of claim 1, wherein said step (B) further comprises:
(B12) varying direction of rotation of said drum to optimize RF coupling by preventing bunching of the drying load.

21. The method of claim 1, wherein said step (B) further comprises:
(B13) selecting parameters of said variable AC electrical field from the group consisting of: an applied RF voltage magnitude and envelope wave shape; an applied RF current magnitude and envelope wave shape; phase of RF voltage vs. current; voltage standing wave ratio (VSWR); and RF frequency.

22. The method of claim 1, wherein step (B) further comprises:
(B14) selecting a connection from a conductive cathode area of said moving enclosure to a ground return path of said RF power source from the group consisting of: a rotating capacitive connection; and a non rotating capacitive connection.

23. The method of claim 1, wherein said step (B) further comprises:
(B15) selecting a connection from at least one said anode element to an RF power source from the group consisting of: a brush-contact commutator; and a capacitive coupling.

24. The method of claim 1, wherein said step (B) further comprises:
(B16) selecting said capacitive coupling from the group consisting of: a parallel plate; and at least one concentric cylinder.

25. The method of claim 1, wherein said step (B) further comprises:
(B17) minimizing a parasitic capacitance of at least one said anode element with RF source during said drying cycle by an optimum placing said anode element with RF source within said enclosure.

26. The method of claim 1, wherein said step (B) further comprises:
(B18) minimizing a parasitic capacitance of said load by mechanically staggering coupling capacitors.

27. The method of claim 1, wherein said step (C) further comprises:
(C1) substantially continuously measuring impedance of said medium including said object having said variable weight during said heating process.

28. The method of claim 27, wherein said step (C1) further comprises:
(C1, 1) using correlation between said continuously measured value of impedance of said medium and a moisture content of said object to determine said moisture content of said object.

29. The method of claim 1, wherein said step (C) further comprises:
(C2) adjusting separately the RF energy feed to at least one said anode element to optimize said heating process.

30. The method of claim 1, wherein said step (C) further comprises:
(C3) adjusting the parameters of said variable AC electrical field to optimize said heating process.

31. The method of claim 1, wherein said step (C) further comprises:
(C4) measuring a set of parameters of said medium including said object having said variable weight during said heating process; said set of parameters selected from the group consisting of: an impedance at least at one RF frequency; temperature variations of said object within said enclosure; moisture variations of said object within said enclosure; and weight variations of said object

32. The method of claim 1, wherein said enclosure comprises a dryer drum version of the enclosure having at least one anode element impellor of variable shape, and at least one cathode area, and wherein said object comprises a load of clothing; and wherein said medium comprises water; and wherein said step (D) further comprises:
(D1) optimally configuring the shape of said at least one impeller to accommodate for different kind of fabrics and different kind of load.

33. The method of claim 1, wherein said enclosure comprises a dryer drum version of the enclosure having at least one anode element impellor of variable shape, and at least one cathode area, and wherein said object comprises a load of clothing; and wherein said medium comprises water; and wherein said step (D) further comprises:
(D2) inserting pre-heated air inside said dryer drum to facilitate water evaporation from said enclosure.

34. The method of claim 1, wherein said enclosure comprises a dryer drum version of the enclosure having at least one anode element impellor of variable shape, and at least one cathode area, and wherein said object comprises a load of clothing; and wherein said medium comprises water; and wherein said step (D) further comprises:
(D3) controlling an air flow rate by volume control to facilitate removal of evaporated water from said enclosure.

35. The method of claim 1, wherein said enclosure comprises a dryer drum version of the enclosure having at least one anode plate impellor of variable shape, and at least one cathode area, and wherein said object comprises a load of clothing; and wherein said medium comprises water; and wherein said step (D) further comprises:
(D4) controlling an air flow path by an element design selected from the group consisting of: an intake air duct design; a chamber design; and a drum impellor design; wherein said element design is configured to facilitate removal of evaporated water from said enclosure.

36. The method of claim 1, wherein said enclosure comprises a dryer drum version of the enclosure having at least one anode plate impellor of variable shape, and at least one cathode area, and wherein said object comprises a load of clothing; and wherein said medium comprises water; and wherein said step (D) further comprises:
(D5) controlling said drum rotation speed and direction.

37. An apparatus for heating an object having a variable weight that includes a medium; said object having said variable weight including said medium is placed into an enclosure; said apparatus comprising:
(A) a means for subjecting said medium including said object having said variable weight to a variable AC electrical field; said applied variable AC electrical field configured to initiate a heating process wherein said medium is heated;
and
(B) a means for controlling said heating process.

38. The apparatus of claim 37 further comprising:
(C) a means for carrying away said evaporated medium from said enclosure.

39. The apparatus of claim 37, said means (A) further comprising:
(A1) an enclosure having at least one anode element.

40. The apparatus of claim 37, said means (A) further comprising:
(A2) an enclosure selected from the group consisting of:
a cylindrical cathode drum having at least one impellor; and a cylindrical drum having at least one impellor and having at least one cathode end plate.

41. The apparatus of claim 37, said means (B) further comprising:
(B1) a means for applying RF energy to at least one said anode element within said enclosure.

42. The apparatus of claim 37, said means (B) further comprising:
(B2) a means for applying RF energy to at least one said impellor configured to function as an anode element inside a drum enclosure; and
wherein at least part of said conductive drum surface is configured to function as a cathode ground return; and wherein at least one said anode element is separated from said conductive drum surface by an insulating material.

43. The apparatus of claim 37, said means (B) further comprising:
(B3) a means for rotating said drum with varying rotation speed to optimize RF coupling.

44. The apparatus of claim 37, said means (B) further comprising:
(B4) a means for varying direction of rotation of said drum to optimize RF coupling by preventing bunching of the drying load.

45. The apparatus of claim 37, said means (B) further comprising:
(B5) a means for controlling said heating process by selecting parameters of said variable AC electrical field from the group consisting of: an applied RF current magnitude and envelope wave shape; an applied RF voltage magnitude and envelope wave shape; an applied constant RF voltage magnitude with variable duty cycle; an applied RF current magnitude and envelope wave shape; an applied constant RF current magnitude with variable duty cycle; phase of RF voltage vs. current; voltage standing wave ratio (VSWR); and RF frequency.

46. The apparatus of claim 38, wherein said enclosure comprises a dryer drum version of the enclosure having at least one anode element impellor of variable shape, and at least one cathode area, and wherein said object comprises a load of clothing; and wherein said medium comprises water; and wherein said means (C) further comprises:
(C1) a means for optimally configuring the shape of said at least one impeller to accommodate for different kind of fabrics and different kind of load.

47. The apparatus of claim 38, wherein said enclosure comprises a dryer drum version of the enclosure having at least one anode element impellor of variable shape, and at least one cathode area, and wherein said object comprises a load of clothing; and wherein said medium comprises water; and wherein said means (C) further comprises:
(C2) a volume control means for controlling an air flow rate to facilitate removal of evaporated water from said enclosure.

48. The apparatus of claim 38, wherein said enclosure comprises a dryer drum version of the enclosure having at least one anode element impellor of variable shape, and at least one cathode area, and wherein said object comprises a load of clothing; and wherein said medium comprises water; and wherein said means (C) further comprises:
(C3) a means for controlling an air flow path by selecting an element design from the group consisting of: an intake air duct design; a chamber design; and a drum impellor design; wherein said element design is configured to facilitate removal of evaporated water from said enclosure.
